(19) United States
(12) Patent Application Publication
(10) Pub. No.: US 2009/0188334 A1
(43) Pub. Date: Jul. 30, 2009

(54) Accessory Gearboxes and Related Gas Turbine Engine Systems

(75) Inventors: Brian D. Merry, Andover, CT (US); Gabriel L. Suciu, Glastonbury, CT (US); Christopher M. Dye, S. Windsor, CT (US); Michael E. McCune, Colchester, CT (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNITED TECHNOLOGIES CORP., Hartford, CT (US)

(21) Appl. No.: 12/019,742

(22) Filed: Jan. 25, 2008

(51) Int. Cl. F16H 37/00

(52) U.S. Cl. 74/15.2

(57) ABSTRACT

Accessory gearboxes and related gas turbine engine systems are provided. In this regard, a representative accessory gearbox for a gas turbine engine is operative to be driven by rotational energy extracted from the gas turbine engine and imparted to the gearbox by multiple tower shafts.

### BACKGROUND

1. Technical Field

The disclosure generally relates to gas turbine engines.

2. Description of the Related Art

Gas turbine engines typically use accessory gearboxes for powering auxiliary components, such as generators and oil pumps, for example. Conventionally, such an accessory gearbox is driven by a tower shaft, which is coupled to the shaft that interconnects the high pressure compressor and the high pressure turbine of the engine.

### SUMMARY

Accessory gearboxes and related gas turbine engine systems are provided. In this regard, an exemplary embodiment of an accessory gearbox for a gas turbine engine is operative to be driven by rotational energy extracted from the gas turbine engine and imparted to the gearbox by multiple tower shafts.

An exemplary embodiment of an accessory assembly for a gas turbine engine comprises: an accessory gearbox operative to be driven by rotational energy extracted from the gas turbine engine; a first tower shaft operative to drive at least a portion of the accessory gearbox with rotational energy extracted from the gas turbine engine; and a second tower shaft operative to drive at least a portion of the accessory gearbox with rotational energy extracted from the gas turbine engine.

An exemplary embodiment of a gas turbine engine comprises: a turbine section; multiple tower shafts operative to extract rotational energy from the turbine section; and an accessory gearbox operative to be driven by rotational energy imparted to the gearbox from the multiple tower shafts.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of a gas turbine engine.

FIG. 2 schematic diagram depicting a portion of the engine of FIG. 1, showing detail of the accessory gearbox.

### DETAILED DESCRIPTION

Accessory gearboxes and related gas turbine engine systems are provided, several exemplary embodiments of which will be described in detail. In some embodiments, an accessory gearbox is integrated with a portion of an engine casing, such as by sharing a wall. By way of example, one side of the wall can be used to define a gas flow path through the engine, while an opposing side of the wall can be used to at least partially house components of the gearbox. Additionally or alternatively, in some embodiments, multiple tower shafts can be used to power the components of the gearbox.

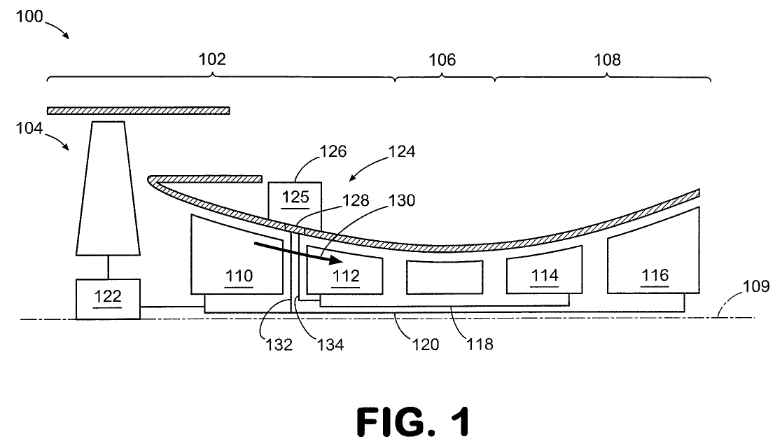

In this regard, reference is made to the schematic diagram of FIG. 1, which depicts an exemplary embodiment of a gas turbine engine. As shown in FIG. 1, engine 100 is a turbofan gas turbine engine that incorporates a compressor section 102 (which includes a fan 104), a combustion section 106 and a turbine section 108 that are located along a longitudinal axis 109. Although depicted as a turbofan gas turbine engine, it should be understood that the concepts described herein are not limited to use with turbofans as the teachings may be applied to other types of gas turbine engines.

Compressor section 102 includes a low pressure compressor 110 and a high pressure compressor 112. The turbine section 108 includes a high pressure turbine 114 and a low pressure turbine 116. In operation, the high pressure turbine 114 drives the high pressure compressor 112 via a high spool (shaft) 118, and low pressure turbine 114 drives the low pressure compressor 110 via a low spool (shaft) 120. Notably, a gearbox 122 (e.g., a differential gear assembly) also is driven by the low spool for rotating the fan 104.

As shown in FIG. 1, engine 100 additionally includes an accessory assembly 124. Accessory assembly 124 incorporates an accessory gearbox 125 that includes a housing 126, which is used to contain internal components of the gearbox. Notably, a wall 128, which forms a portion of a gas flow path through the engine (a portion of which is depicted by arrow 130) is integrated with the housing to contain the internal components. This integration tends to reduce weight of the engine.

In this embodiment, wall 128 is an outer wall of a transition duct that extends between the low pressure compressor 110 and the high pressure compressor 112. Positioning of the accessory gearbox in such a forward, cooler location in the engine compartment may tend to improve gearbox component life.

Gearbox 125 is used to provide rotational energy extracted by the turbine section 108 to various accessories associated with the gearbox. For instance, such accessories can include oil pumps and electrical generators. In order to transmit the rotational energy from the turbine section to gearbox 125, tower shafts of the accessory assembly are used. Specifically, a tower shaft 132 is coupled between low spool 120 and gearbox 125, and a tower shaft 134 is coupled between high spool 118 and gearbox 124.

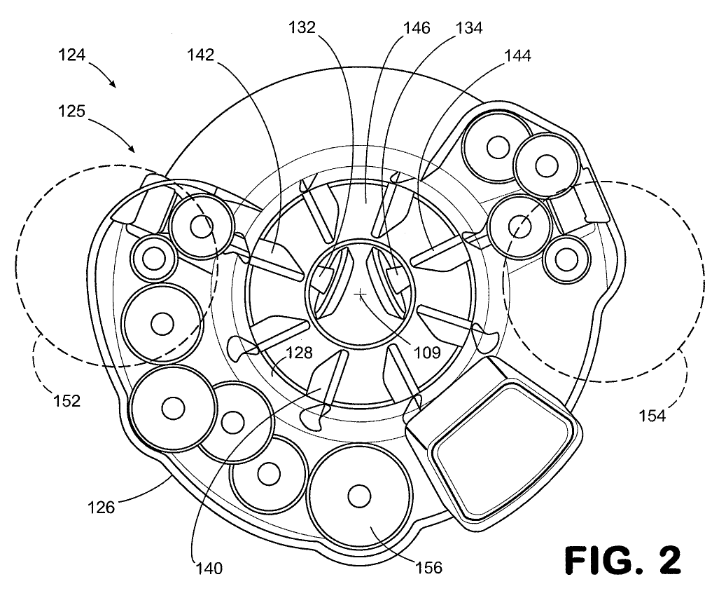

As shown in greater detail in FIG. 2, tower shafts 132 and 134 extend radially outwardly from longitudinal axis 109, with each tower shaft being located at a different circumferential position about the longitudinal axis. In this embodiment, tower shaft 132 is generally located at the 10 o'clock position and tower shaft 134 is generally located at the 2 o'clock position as viewed from the rear of the engine. Notably, in other embodiments, various other numbers and positions of tower shafts can be used.

Also shown in FIG. 2 are fairings (e.g., fairings 140, 142 and 144) that extend radially across the gas flow path between wall 128 and inner transition duct wall 146.

Cavities (not shown) located within fairings 142 and 144 permit passage of the tower shafts through the fairings. Specifically, tower shaft 132 extends through fairing 142, and tower shaft 134 extends through fairing 144. Notably, the use of multiple tower shafts enables shafts of smaller diameter to be used for transmitting rotational energy to the accessory gearbox. As such, the multiple tower shafts negatively impact airflow through the portion of the engine through which the tower shafts pass to a lesser extent than does a single, wider tower shaft. In this embodiment, support struts (not shown) extend through the remaining fairings, e.g., fairing 140.

Use of multiple tower shafts also enables at least one of the tower shafts (such as in the embodiment of FIGS. 1 and 2) to be driven by other than the high spool (e.g., by the low spool in a two spool engine). As such, energy extraction from the high spool can be reduced. Notably, coupling of at least one tower shaft to a high spool typically is required for engine start, particularly in those embodiments that incorporate starter/generators driven by the accessory gearbox.

In the embodiment of FIGS. 1 and 2, each of the tower shafts independently powers a separate starter/generator. Specifically, tower shaft 132 powers starter/generator 152, and tower shaft 134 powers starter/generator 154.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. An accessory assembly for a gas turbine engine comprising:
an accessory gearbox operative to be driven by rotational energy extracted from the gas turbine engine;
a first tower shaft operative to drive at least a portion of the accessory gearbox with rotational energy extracted from the gas turbine engine; and
a second tower shaft operative to drive at least a portion of the accessory gearbox with rotational energy extracted from the gas turbine engine.

2. The accessory assembly of claim 1, wherein:
the engine has a first spool operative to interconnect a first compressor and a first turbine, and a second spool operative to interconnect a second compressor and a second turbine; and
the first tower shaft is operative to be driven by the first spool; and
the second tower shaft is operative to be driven by the second spool.

3. The accessory assembly of claim 1, wherein the first tower shaft and the second tower shaft extend radially outwardly from a longitudinal axis of the engine at different circumferential locations.

4. The accessory assembly of claim 1, further comprising a first generator operative to be driven, at least in part, by the first tower shaft.

5. The accessory assembly of claim 4, further comprising a second generator operative to be driven, at least in part, by the second tower shaft.

6. The accessory assembly of claim 1, further comprising:
a first generator operative to be driven, independently, by the first tower shaft; and
a second generator operative to be driven, independently, by the second tower shaft.

7. The accessory assembly of claim 6, wherein the first generator is a starter/generator.

8. An accessory gearbox for a gas turbine engine operative to be driven by rotational energy extracted from the gas turbine engine and imparted to the gearbox by multiple tower shafts.

9. The accessory gearbox of claim 8, wherein the multiple tower shafts consist of two tower shafts.

10. The accessory gearbox of claim 8, wherein the accessory gearbox is configured such that a first tower shaft is operative to drive at least a portion of the accessory gearbox with rotational energy extracted from the gas turbine engine and a second tower shaft is operative to drive at least a portion of the accessory gearbox with rotational energy extracted from the gas turbine engine.

11. A gas turbine engine comprising:
a turbine section;
multiple tower shafts operative to extract rotational energy from the turbine section; and
an accessory gearbox operative to be driven by rotational energy imparted to the gearbox from the multiple tower shafts.

12. The engine of claim 11, wherein:
the engine further comprises an annular gas flow path and fairings extending across the gas flow path; and
each of the multiple tower shafts extends across the annular gas flow path through an interior of a corresponding one of the fairings.

13. The engine of claim 12, wherein:
the engine further comprises a low pressure compressor and a high pressure compressor; and
the annular gas flow path is located between the low pressure compressor and the high pressure compressor.

14. The engine of claim 11, wherein:
the engine further comprises a wall defining at least a portion of the annular gas flow path; and
the accessory gearbox comprises a housing; and
the housing and the wall are attached to form an enclosure.

15. The engine of claim 11, wherein:
the engine further comprises a first spool and a second spool; and
a first of the multiple tower shafts is driven by the first spool; and
a second of the multiple tower shafts is driven by the second spool.

16. The engine of claim 11, wherein at least one of the multiple tower shafts is driven by a high spool of the engine and at least another of the multiple tower shafts is driven by a spool other than the high spool of the engine.

17. The engine of claim 11, further comprising:
a first generator operative to be driven by a first tower shaft of the multiple tower shafts; and
a second generator operative to be driven by a second tower shaft of the multiple tower shafts.

18. The engine of claim 11, wherein the multiple tower shafts comprise:
a first tower shaft operative to drive at least a portion of the accessory gearbox; and
a second tower shaft operative to drive at least a portion of the accessory gearbox.

19. The engine of claim 11, wherein the engine is a turbofan gas turbine engine having a fan.

20. The engine of claim 19, wherein:
the engine further comprises a differential gear assembly; and
the fan is operative to be driven by the differential gear assembly.
